(19) United States
(12) Patent Application Publication
(10) Pub. No.: US 2009/0263014 A1
(43) Pub. Date: Oct. 22, 2009

(54) CONTENT FINGERPRINTING FOR VIDEO AND/OR IMAGE

(75) Inventors: Ruofei Zhang, San Jose, CA (US); Ramesh Sarukkai, Union City, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/105,170

(22) Filed: Apr. 17, 2008

(51) Int. Cl. G06K 9/00

(52) U.S. Cl. 382/165

(57) ABSTRACT

The subject matter disclosed herein relates to generating a fingerprint for identifying electronic video files based at least in part on color correlograms.

### BACKGROUND

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided, which allow for the copious amounts of information to be searched through in an efficient manner. For example, service providers may allow for users to search the World Wide Web or other like networks using search engines. Similar tools or services may allow for one or more databases or other like data repositories to be searched.

With so much information being available, there is a continuing need for methods and systems that allow for pertinent information to be analyzed in an efficient manner. For example, a search engine may rely upon content providers to establish the location of the content and descriptive search terms to enable users of the search engine to find the content. Alternatively, the search engine registration process may be automated. A content provider may place one or more metatags into a web page or other content. Each metatag may contain keywords that a search engine can use to index the page. To search for Internet content, a search engine may use a web crawler, which may automatically crawl through web pages following every link from one web page to other web pages until all links are exhausted. As the web crawler crawls through web pages, the web crawler may correlate descriptive metatags on each web page with the location of the page to construct a searchable database.

### DESCRIPTION OF THE DRAWING FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a flow diagram illustrating a procedure for generation of a fingerprint from the content of video files in accordance with one or more embodiments;

FIG. 2 is a flow diagram illustrating a procedure for key frame extraction from the content of video files in accordance with one or more embodiments;

FIG. 3 is a flow diagram illustrating a procedure for generation of color correlograms from the content of video files in accordance with one or more embodiments; and

FIG. 4 is a schematic diagram of a computing platform in accordance with one or more embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In many multimedia applications, such as video database and video search, it may often be difficult to detect duplicated or similar video files efficiently. The term “video file” as used herein may include, but is not limited to, a recording that may contain one or more image frames. Such video files may be formatted in one or more of the following formats Moving Picture Experts Group MPEG, Windows Media Video (WMV), High-definition television (HDTV), and/or the like, although these are only examples and this is not an exhaustive list of such formats. If duplicated and/or similar video files are detected, such information may be utilized for collapsing of duplicated and/or similar video files. For example, in an Internet search context, such a collapsing of duplicated and/or similar video files may limit the number of duplicated and/or similar video files that are presented to a user as the result of a search. Additionally or alternatively, information regarding detection of duplicated and/or similar video files may be utilized for de-duplication of video files. For example, such de-duplication may involve isolation, removal and/or deletion of extraneously duplicative video files from an index and/or database. Additionally or alternatively, information regarding detection of duplicated and/or similar video files may be utilized for copyright detection. For example, identification of illicit copies, derivative works, and/or tracking licensed usage may be facilitated by such detection of duplicated and/or similar video files. Such operations of collapsing, de-duplication, and/or copyright detection may reduce the processing, indexing, and/or storage demands generated by duplicated video files in order to save both computation power and storage resources.

Video content, being more content-rich, has become a more common content form. As with text content, the vast amount of video content is distributed widely across many locations. However, video content does not lend itself to easy searching techniques because video content often does not contain text that is easily searchable by currently available search engines. Additionally, two video files may have different layouts or formats but may contain similar or substantially the same content. In this sense, the video files may be members of an image family or grouping, but due to their layout differences, may not be identical. For example, video files having similar content may be positioned in different formats, such as landscape or portrait. In this sense, though the video file content is substantially the same, the images from the video file are not identical due to formatting differences.

Existing technologies for identifying video files may be based on hash of the metadata of video files. In such systems, a fingerprint may be generated based on such metadata, and the videos having the same fingerprint may be collapsed. There are several drawbacks to this technology. First, not every video file has metadata available. Second, even if the metadata of two video files are exactly the same, it does not necessarily follow that the two video files are the same or even similar. Third, two similar video files may not have exactly the same metadata associated, and such metadata based systems may be unable to identify duplicate video files.

Embodiments described herein relate to, among other things, generation of a fingerprint from the content of video files. Such content based fingerprints may have an increased accuracy and may be less prone to error than metadata based fingerprints. In addition, such content based fingerprints, as described below, may be designed so as to robustly identify duplicate video files even in many instances where duplicate video files have been altered in size, scaling, rotation, orientation, different encoding, and/or simple editing. Further, existing fingerprinting systems have focused on metadata based fingerprints as text processing and hashing may be much simpler than image/video processing and/or hashing. For example, there may be many challenges to process and extract features from image/video. Content-based understanding and indexing for image/video is a developing research field. In addition, metadata based hashing is often not directly operable for numerical vector based hashing, such as with correlograms, for example.

A procedure for generation of a fingerprint from the content of video files will be described in greater detail below. In general, such a procedure for generation of a fingerprint from the content of video files may include segmenting an electronic video file into a plurality of image frames. At least one key frame may be extracted from a portion of selected image frames. The term “key frame” as used herein may include, but is not limited to, at least a portion of a video file that contains high value visual information such as unique visual characteristics, distinguishing visual characteristics, and/or the like. Alternatively, at least one key frame may be extracted from a portion of a video file, without performing a segmentation of the video file. From each segmented set of image frames, one key frame may be extracted to represent the video file based at least in part on one or more measurements of visual importance. Color information may be extracted from pixels in the extracted key frames. For example, red-green-blue (RGB) values may be extracted from pixels in the extracted key frames. A color correlo ram may be generated based at least in part on a spatial distribution of pixels from an extracted key frame. For example, RGB values may be quantized into 64 bins and a color correlogram may be generated based on the quantization and the distances between pixels. A fingerprint identifying the electronic video file may be generated based at least in part on the generated color correlogram. For example, a hash function may be designed to compute a 64-bit content based fingerprint from the color correlogram. Such content based fingerprints may be utilized for operations of collapsing, de-duplication and/or copyright detection, for example.

Such content based fingerprints may be generated utilized to enhance the speed and/or accuracy of video file duplication identification. For example, the operation of computing content based fingerprints via a hash function permits detection of video file duplication at a speed fast enough to be scalable to web-scale image/video search operations. Further, such content based fingerprints may robustly identify duplicate video files, even in many instances where duplicate video files have been altered in size, scaling, rotation, orientation, different encoding, and/or simple editing. For example, the operation of quantization of color information from the key frames may render resultant content based fingerprints invariant to minor variations of the video/key frame.

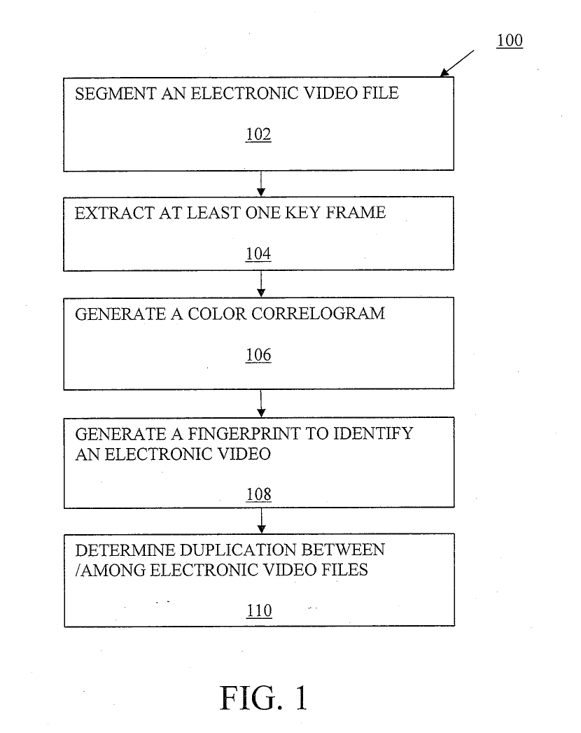

Procedure 100, as illustrated in FIG. 1, may be used for generation of a fingerprint from the content of video files in accordance with one or more embodiments, for example, although the scope of claimed subject matter is not limited in this respect. Additionally, although procedure 100, as shown in FIG. 1, comprises one particular order of blocks, the order in which the blocks are presented does not necessarily limit claimed subject matter to any particular order. Likewise, intervening blocks shown in FIG. 1 and/or additional blocks not shown in FIG. 1 may be employed and/or blocks shown in FIG. 1 may be eliminated, without departing from the scope of claimed subject matter.

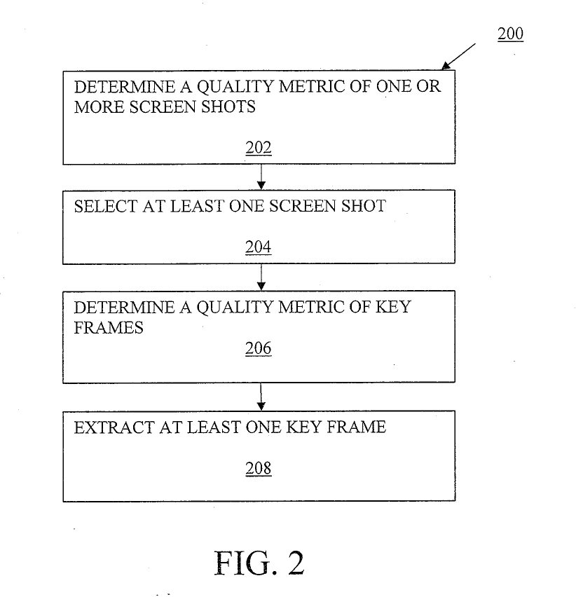

Procedure 100 depicted in FIG. 1 may in alternative embodiments be implemented in software, hardware, and/or firmware, and may comprise discrete operations. As illustrated, procedure 100 may be used for generation of a fingerprint from the content of video files. Procedure 100 may be used for generation of a fingerprint from the content of electronic video files starting at block 102 where one or more electronic video files may be segmented into a plurality of image frames. Such video segmentation may segment electronic video files into image frames. For example, an electronic video file that comprises a still image may only be segmented into a single image frame, while an electronic video file that comprises a series of still images representing scenes in motion may be segmented into a plurality of individual image frames. At block 104 at least one key frame may be extracted from a portion of at least one of the image frames for each electronic video file. For example, from each segmented image frame, one or more key frames may be extracted to represent the video file based at least in part on one or more measurements of visual importance. Such selection of an extracted key frame may allow identification of an electronic video file based on a small portion of the entire video file. In one embodiment, the extracted key frame may be smaller in size than the entire electronic video file; accordingly, computational expenditures during analysis of the key frame may be reduced as compared to a similar analysis of an entire electronic video file. Further, such a selection of an extracted key frame also may ensure the accuracy of such identification. For example, due to the selection of the key frame based on a quality metric analysis, as will be discussed in greater detail below with respect to FIG. 2, such an extracted key frame may be more likely to accurately identify an electronic video file. Conversely, an analysis based on a lower quality portion of the electronic video file may be less likely to accurately identify an electronic video file. Alternatively, at least one key frame may be extracted from a portion of a video file, without performing a segmentation of the video file.

For example, referring to FIG. 2, a flow diagram illustrates an example procedure in accordance with one or more embodiments, although the scope of claimed subject matter is not limited in this respect. Here, procedure 200 may be used for extraction of a key frame from the content of video files in accordance with one or more embodiments, for example, although the scope of claimed subject matter is not limited in this respect. At block 202 a quality metric may be determined for at least one image frame. For example, such a quality metric may comprise a quantification of resolution and/or color depth of image frames. At block 204 at least one image frame may be selected based at least in part on the determined quality metrics of image frames. At block 206 a quality metric may be determined for at least one key frame. For example, such a quality metric may comprise a quantification of resolution and/or color depth of the key frames. At block 208 at least one key frame may be extracted from a portion of at least one of the image frames for each electronic video file. Such an extracted key frame may be selected based at least in part on the determined quality metrics of the key frames. Additionally or alternatively, such quality metric analysis of image frames and/or key frames may be performed according to procedures set forth in more detail in Defaux, F., “Key frame selection to Represent a Video”, IEEE International Conference on Image Processing 2000. Such quality metric analysis may be based at least in part on extracted features, such as spatial color distributions, texture, facial recognition, object recognition, shape features, and/or the like. However, this is merely an example of determining such a key frame, and the scope of claimed subject matter is not limited in this respect.

Referring back to FIG. 1, at block 106 a color correlogram may be generated based at least in part on a distribution of pixels from an extracted key frame. Such color correlograms may be used to describe images. The term “color correlogram” as used herein may represent a probability distribution of pixel colors including a spatial component within an image. For example, color correlograms may represent a probability of finding a pixel of a selected color at a selected distance from a second pixel of the selected color within an image. Such a correlogram may express how the color information from the key frames changes with distance within an image. In this sense, a color correlogram may encode spatial co-occurrence of image colors i and j as the probability of finding i and j within an area of radius d at a distance k in the image. This may be expressed as a three dimensional vector (i,j,k). Color correlograms may employ pixel information including pixel color and spatial information associated with distances between pixels within an image. For example, color information from the key frames may be quantized into 64 values in a particular color-space. The term “color information” as used herein may include, but is not limited to, information from the following color spaces: RGB, L*a*b* (luminance, red/blue chrominance and yellow/blue chrominance), L*u*v* (luminance, red/green chrominance and yellow/blue chrominance), CMYK (Cyan, Magenta, Yellow and Black), CIE 1931 XYZ (International Commission on Illumination XYZ), CIE 1964, or the like. Distance values may be determined for distances between pixels in an image, and a maximum distance may be determined for pixels within an image.

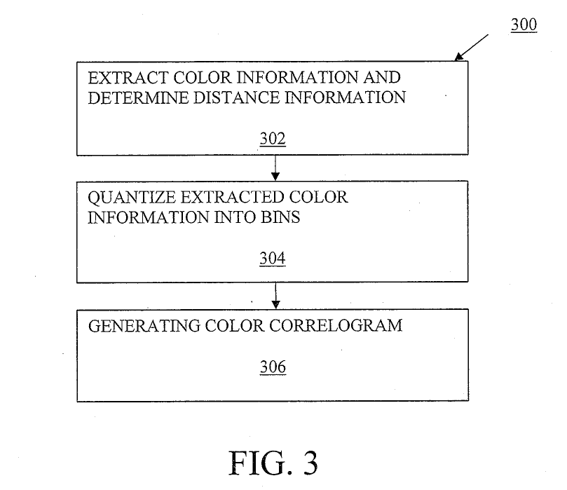

Procedure 300, as illustrated in FIG. 3, may be used for generating color correlograms in accordance with one or more embodiments, for example, although the scope of claimed subject matter is not limited in this respect. At block 302 color information may be extracted from pixels in the extracted key frame and distance information may be selected for distances between pixels in the extracted key frame. Such pixels may comprise color information for identifying a pixel's color and/or distance information regarding distances between pixel sets. For example, correlograms may be built by selecting a pixel and identifying its color (Ci). A distance may be selected. Pixels located at the selected distance, as measured from the selected pixel, having the same color Ci as the query pixel and having a color Cj contribute to correlogram bin corresponding to pair (Ci, Cj) where Ci and Cj can be any color between C1 to Cmax (i.e. Ci is not necessarily equal to Cj) may be counted. This process may be carried out for all image pixels for each selected distance. In this manner, some or all pixels within an image may be analyzed. In this manner, in this embodiment, a color correlogram may be built for an image. This may be repeated for some or all images represented. This embodiment is merely one example of building a correlogram and claimed subject matter is not intended to be limited to this particular type of correlogram building.

A color correlogram represent spatial correlation of color within an image in a data object, which may be associated with an image and subsequently stored in a database and queried to analyze the image. As discussed in U.S. Pat. No. 6,246,790 (“the '790 patent”), color correlograms, including banded color correlograms, may be used to describe images. At block 304 extracted color information may be quantized into two or more bins. For example, as described in the '790 patent, colors may be quantized into colors C1 to Cmax and distances between pixels, such as the distance between pixels p1 and p2, where p1=(x1,y1) and p2=(x2,y2), may be represented by:

|p1−p2|=max{|x1−x2|,|y1−y2|}

Correlogram identification of the image may include calculating distances k for all of the quantized color pairs (Ci, Cj). The image correlogram, I_{c}, may be represented as a matrix. The following quantities are defined, which count the number of pixels of a given color C within a given distance k from a fixed pixel (x,y) in the positive horizontal (represented by h) and vertical (represented by v) directions:

λ^{c,h}_{(x,y)}(k)=|{(x+i,y)εIc|0≦i≦k|}|

λ^{c,v}_{(x,y)}(k)=|{(x,y+j)εIc|0≦j≦k|}|

These particular expressions represent a restricted count of the number of pixels, to horizontal and vertical directions, in lieu of a radius approach. A radius approach may also be employed in some embodiments.

For this embodiment, the λ^{c,h}_{(x,y)}(k) and λ^{c,v}_{(x,y)}(k) values may be calculated using dynamic programming. At block 306 a color correlogram may be generated based at least in part on such a quantization of the extracted color information and the selected distance information. For example, the correlogram may then be computed by first computing the “co-occurrence matrix” as:

Γ^{(k)}_{ci,cj}(I)=Σ_{(x,y)εIci}(λⱼ^{c,h}_{(x-k,y+k)}(2k+λⱼ^{c,h}_{(x-k,y-k)}(2k)+λⱼ^{c,v}_{(x-k,y-k+1)}(2k−2)+λⱼ^{c,v}_{(x+k,y-k+1)}(2k−2))

And from which the correlogram entry for (cᵢ, cⱼ, k) may be computed as:

γ^{(k)}_{ci,cj(I)}=Γ^{(k)}_{ci,cj}(I)/(8k*H_{ci}(i))

where Hcᵢ represents a bin corresponding to color Ci under consideration. Again, this is merely one method of building a correlogram and claimed subject matter is not intended to be limited to this example.

In some embodiments, banded correlograms may be built. Whereas correlograms may be represented by a three dimensional vector (i,j,k), for banded color correlograms, distance (k) may be fixed such that the correlogram may be represented by a two dimensional vector (ij) where the value at position i and j is the probability of finding color i and j together within a fixed radius of k pixels. The two dimensional vector may comprise a series of summed probability values.

Referring back to FIG. 1, at block 108 a fingerprint may be generated that is capable of identifying individual electronic video files based at least in part on such a generated color correlogram. For example, a hash function may be designed to compute a 64-bit content based fingerprint from the color correlogram. Such content based fingerprints may be utilized for operations of collapsing, de-duplication and/or copyright detection, for example. One such hash function may comprise a “Fowler/Noll/Vo” (FNV) hash algorithm.

At block 110 a duplication between and/or among two or more electronic video files may be determined based at least in part on such a fingerprint. For example, fingerprints associated with individual electronic video files may be compared so as to determine if two electronic video files are substantial duplicates. For example, a plurality of electronic video files may be provided, such as from a database, crawled from Internet, and/or from a result of an Internet search, for example. Such electronic video files may be analyzed and a content based fingerprint may be calculated for each electronic video file. Any substantially duplicated electronic video files may be detected based at least in part on a comparison of such content based fingerprints. Such a comparison may be utilized for detection of copyright violation by detecting illicit duplicate electronic video files. Alternatively or additionally, such a comparison may be utilized for de-duplication of the electronic video files by collapsing redundant files. For example, similar electronic video files may be merged into groups or families. The similar electronic video files being grouped may be near-duplicates for some applications, and/or the similar electronic video files being grouped may be identical for other applications.

Additionally or alternatively, aside from using the spatial-color distribution of key frames extracted from electronic video files to generate content based fingerprints, other content features may also be utilized for operations of collapsing, de-duplication and/or copyright detection. One such feature includes audio pitch. For example, sound track information may be extracted from electronic video files. Pitch features may then be extracted from such sound track information to represent the audio characteristics of the electronic video file. Another such feature includes motion vectors. For example, video content analysis techniques may be utilized to extract motion vectors from the consecutive key frames and/or image frames. Such motion vectors model motion features that capture the motion characteristics of the electronic video file. Such spatial-color distribution of key frames feature, audio pitch feature, and/or motion vector feature may be utilized to complement each other for operations of collapsing, de-duplication operations and/or copyright detection. When using a combination of these features, each feature may be described as individual feature vectors. Those feature vectors (spatial-color distribution of key frames feature, audio pitch feature, and/or motion vector feature) may be combined into one common feature vector to generate a common fingerprint. Such a common fingerprint may capture many properties of the electronic video file, which might affect video viewers' perceptions of the uniqueness of the video. Thus, the effectiveness of fingerprints that utilize a combination of features, such as spatial-color distribution of key frames feature, audio pitch feature, and/or motion vector feature, may be improved. Such an audio pitch feature and/or motion vector feature may be incorporated with the above described procedures for generating a content-based fingerprinting system based on spatial-color distribution of key frames. Such features may be calculated as a vector of float numbers. For example, such features may be calculated in a manner similar to that disclosed above for calculating correlograms and then may be concatenated with a correlogram vector to provide a final vector for use in generating a fingerprint.

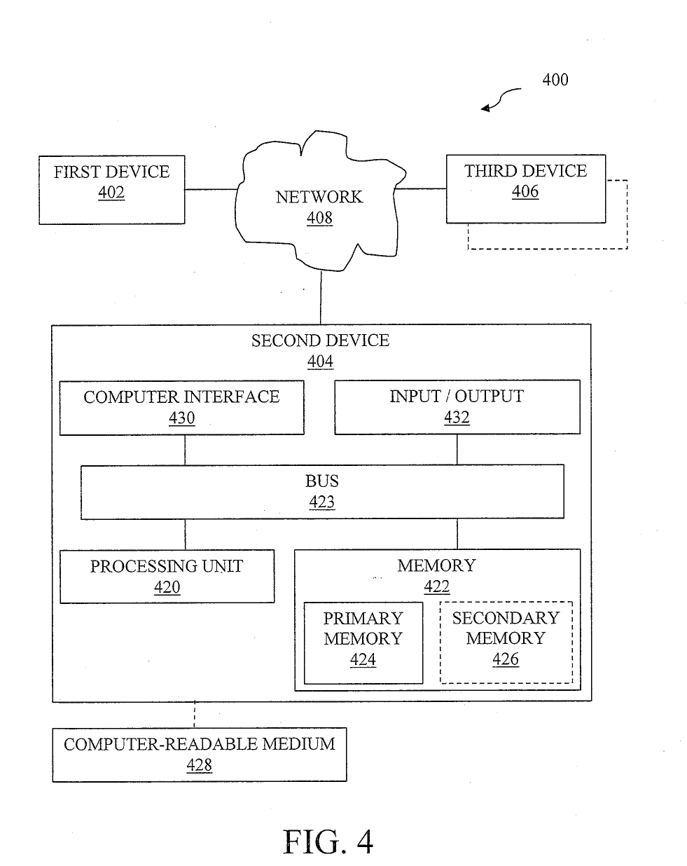

FIG. 4 is a schematic diagram illustrating an exemplary embodiment of a computing environment system 400 that may include one or more devices configurable to generate a fingerprint for identifying electronic video files based at least in part on color correlograms using one or more techniques illustrated above, for example. System 400 may include, for example, a first device 402, a second device 404, and a third device 406, which may be operatively coupled together through a network 408.

First device 402, second device 404, and third device 406, as shown in FIG. 4, may be representative of any device, appliance or machine that may be configurable to exchange data over network 408. By way of example, but not limitation, any of first device 402, second device 404, or third device 406 may include: one or more computing devices and/or platforms, such as, e.g., a desktop computer, a laptop computer, a workstation, a server device, or the like; one or more personal computing or communication devices or appliances, such as, e.g., a personal digital assistant, mobile communication device, or the like; a computing system and/or associated service provider capability, such as, e.g., a database or data storage service provider/system, a network service provider/system, an Internet or intranet service provider/system, a portal and/or search engine service provider/system, a wireless communication service provider/system; and/or any combination thereof.

Similarly, network 408, as shown in FIG. 4, is representative of one or more communication links, processes, and/or resources configurable to support the exchange of data between at least two of first device 402, second device 404, and third device 406. By way of example, but not limitation, network 408 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated, for example, by the dashed lined box illustrated as being partially obscured of third device 406, there may be additional like devices operatively coupled to network 408.

It is recognized that all or part of the various devices and networks shown in system 400, and the processes and methods as further described herein, may be implemented using, or otherwise including, hardware, firmware, software, or any combination thereof.

Thus, by way of example, but not limitation, second device 404 may include at least one processing unit 420 that is operatively coupled to a memory 422 through a bus 423.

Processing unit 420 is representative of one or more circuits configurable to perform at least a portion of a data computing procedure or process. By way of example, but not limitation, processing unit 420 may include one or more processors, controllers, microprocessors, microcontrollers, application specific integrated circuits, digital signal processors, programmable logic devices, field programmable gate arrays, and the like, or any combination thereof.

Memory 422 is representative of any data storage mechanism. Memory 422 may include, for example, a primary memory 424 and/or a secondary memory 426. Primary memory 424 may include, for example, a random access memory, read only memory, etc. While illustrated in this example as being separate from processing unit 420, it should be understood that all or part of primary memory 424 may be provided within or otherwise co-located/coupled with processing unit 420.

Secondary memory 426 may include, for example, the same or similar type of memory as primary memory and/or one or more data storage devices or systems, such as, for example, a disk drive, an optical disc drive, a tape drive, a solid state memory drive, etc. In certain implementations, secondary memory 426 may be operatively receptive of, or otherwise configurable to couple to, a computer-readable medium 428. Computer-readable medium 428 may include, for example, any medium that can carry and/or make accessible data, code and/or instructions for one or more of the devices in system 400.

Second device 404 may include, for example, a communication interface 430 that provides for or otherwise supports the operative coupling of second device 404 to at least network 408. By way of example, but not limitation, communication interface 430 may include a network interface device or card, a modem, a router, a switch, a transceiver, and the like.

Second device 404 may include, for example, an input/output 432. Input/output 432 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 432 may include an operatively configured display, speaker, keyboard, mouse, trackball, touch screen, data port, etc.

With regard to system 400, in certain implementations, first device 402 may be configurable to tangibly embody all or a portion of procedure 100 of FIG. 1, procedure 200 of FIG. 2, and/or procedure 300 of FIG. 3. In certain implementations, first device 402 may be configurable to generate a fingerprint for identifying electronic video files based at least in part on color correlograms using one or more techniques illustrated above. For example, we can apply a process in first device 402 where a plurality of electronic video files may be provided, such as from a database, crawled from Internet, and/or from a result of an Internet search, for example. First device 402 may analyze each of the electronic video files and calculate a content based fingerprint for each electronic video file. First device 402 may determine if there are any substantially duplicated electronic video files based at least in part on a comparison of the content based fingerprints. Such a comparison may be utilized by the first device 402 for de-duplication of the electronic video files by collapsing redundant files. Alternatively or additionally, such a comparison may be utilized by the first device 402 for detection of copyright violation by detecting illicit duplicate electronic video files.

Embodiments claimed may include algorithms, programs and/or symbolic representations of operations on data bits or binary digital signals within a computer memory capable of performing one or more of the operations described herein. A program and/or process generally may be considered to be a self-consistent sequence of acts and/or operations leading to a desired result. These include physical manipulations of physical quantities. Usually, though not necessarily, these quantities take the form of electrical and/or magnetic signals capable of being stored, transferred, combined, compared, and/or otherwise manipulated. It has proven convenient at times, principally for reasons of common usage, to refer to these signals as bits, values, elements, symbols, characters, terms, numbers and/or the like. It should be understood, however, that all of these and/or similar terms are to be associated with the appropriate physical quantities and are merely convenient labels applied to these quantities.

Unless specifically stated otherwise, as apparent from the preceding discussion, it is appreciated that throughout this specification discussions utilizing terms such as processing, computing, calculating, selecting, forming, transforming, defining, mapping, converting, associating, enabling, inhibiting, identifying, initiating, communicating, receiving, transmitting, determining, displaying, sorting, applying, varying, delivering, appending, making, presenting, distorting and/or the like refer to the actions and/or processes that may be performed by a computing platform, such as a computer, a computing system, an electronic computing device, and/or other information handling system, that manipulates and/or transforms data represented as physical electronic and/or magnetic quantities and/or other physical quantities within the computing platform's processors, memories, registers, and/or other information storage, transmission, reception and/or display devices. Further, unless specifically stated otherwise, processes described herein, with reference to flow diagrams or otherwise, may also be executed and/or controlled, in whole or in part, by such a computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or chances that fall within the true spirit of claimed subject matter.

What is claimed is:

1. A method, comprising:
generating a color correlogram based at least in part on a distribution of pixels from at least one key frame, said key frame being extracted from an electronic video file;
generating a fingerprint identifying said electronic video file based at least in part on said color correlogram; and
determining duplication between and/or among two or more electronic video files based at least in part on said fingerprint.

2. The method of claim 1, further comprising:
segmenting said electronic video file into a plurality of image frames;
determining a quality metric of at least one of said plurality of image frames;
selecting at least one of said plurality of image frames based at least in part on said quality metric; and
extracting said at least one key frame from a portion of at least one of said plurality of image frames based at least in part on said selected image frames.

3. The method of claim 1, further comprising:
determining a quality metric of said at least one key frame; and
extracting said at least one key frame from said electronic video file based at least in part on said quality metric.

4. The method of claim 1, further comprising:
segmenting said electronic video file into a plurality of image frames;
determining a quality metric of at least one of said plurality of image frames, wherein said quality metric of said plurality of image frames comprises a quantification of resolution and/or color depth;
selecting at least one of said plurality of image frames based at least in part on said quality metric of said plurality of image frames;
determining a quality metric of said at least one key frame, wherein said quality metric of said at least one key frame comprises a quantification of resolution and/or color depth; and
extracting said at least one key frame from a portion of at least one of said plurality of image frames based at least in part on said quality metric of said at least one key frame.

5. The method of claim 1, wherein said generating said color correlogram further comprises:
extracting color information from pixels in said at least one key frame;
quantizing said extracted color information into two or more bins; and
wherein said generating said color correlogram comprises generating said color correlogram based at least in part on said quantization of said extracted color information.

6. The method of claim 1, wherein said pixels comprise color information and spatial information associated with distances between pixels within at least one of said images.

7. The method of claim 1, wherein said generating said color correlogram further comprises:
extracting color information from pixels in said at least one key frame;
quantizing said extracted color information into two or more bins;
selecting spatial information associated with distances between said pixels in said at least one key frame; and
wherein said generating said color correlogram comprises generating said color correlogram based at least in part on said quantization of said extracted color information and said selected distance information.

8. The method of claim 1, wherein said generating said fingerprint further comprises generating said fingerprint identifying said electronic video file based at least in part a hash function of said color correlogram.

9. The method of claim 1, further comprising:
extracting audio pitch information from said electronic video file; and
generating said fingerprint identifying said electronic video file based at least in part on said audio pitch information in addition to said color correlogram.

10. The method of claim 1, further comprising:
extracting motion vector information from said electronic video file; and
generating said fingerprint identifying said electronic video file based at least in part on said motion vector information in addition to said color correlogram.

11. An article comprising:
a storage medium comprising machine-readable instructions stored thereon which, if executed direct a computing platform to:
generate a color correlogram based at least in part on a distribution of pixels from at least one key frame, said key frame being extracted from an electronic video file;
generate a fingerprint identifying said electronic video file based at least in part on said color correlogram; and
determine duplication between and/or among two or more electronic video files based at least in part on said fingerprint.

12. The article of claim 11, wherein said machine-readable instructions, if executed by a computing platform, further result in:
segment an electronic video file into a plurality of image frames;
determine a quality metric of at least one of said plurality of image frames, wherein said quality metric of said plurality of image frames comprises a quantification of resolution and/or color depth;
select at least one of said plurality of image frames based at least in part on said quality metric of said plurality of image frames;
determine a quality metric of said at least one key frame, wherein said quality metric of said at least one key frame comprises a quantification of resolution and/or color depth; and
extract said at least one key frame from a portion of at least one of said plurality of image frames based at least in part on said quality metric of said at least one key frame.

13. The article of claim 11, wherein said machine-readable instructions, if executed by a computing platform, further result in:
extract color information from pixels in said at least one key frame;
quantize said extracted color information into two or more bins;
select spatial information associated with distances between said pixels in said at least one frame; and
wherein said generation of said color correlogram comprises generating said color correlogram based at least in part on said quantization of said extracted color information and said selected distance information.

14. The article of claim 11, wherein said generation of said fingerprint further comprises generating said fingerprint identifying said electronic video file based at least in part a hash function of said color correlogram.

15. The article of claim 11, wherein said machine-readable instructions, if executed by a computing platform, further result in:
extract audio pitch information from said electronic video file;
extract motion vector information from said electronic video file; and
generate said fingerprint identifying said electronic video file based at least in part on said audio pitch information as well as on said motion vector information in addition to said color correlogram.

16. An apparatus comprising:
a computing platform, said computing platform being adapted to:
generate a color correlogram based at least in part on a distribution of pixels from at least one key frame, said key frame being extracted from an electronic video file;
generate a fingerprint identifying said electronic video file based at least in part on said color correlogram; and
determine duplication between and/or among two or more electronic video files based at least in part on said fingerprint.

17. The apparatus of claim 16, wherein said computing platform is further adapted to:
segment an electronic video file into a plurality of image frames;
determine a quality metric of at least one of said plurality of image frames, wherein said quality metric of said plurality of image frames comprises a quantification of resolution and/or color depth;
select at least one of said plurality of image frames based at least in part on said quality metric of said plurality of image frames;
determine a quality metric of said at least one key frame, wherein said quality metric of said at least one key frame comprises a quantification of resolution and/or color depth; and
extract said at least one key frame from a portion of at least one of said plurality of image frames based at least in part on said quality metric of said at least one key frame.

18. The apparatus of claim 16, wherein said computing platform is further adapted to:
extract color information from pixels in said at least one key frame;
quantize said extracted color information into two or more bins;
select spatial information associated with distances between said pixels in said at least one key frame; and
wherein said generation of said color correlogram comprises generating said color correlogram based at least in part on said quantization of said extracted color information and said selected distance information.

19. The apparatus of claim 16, wherein said generation of said fingerprint further comprises generating said fingerprint identifying said electronic video file based at least in part a hash function of said color correlogram.

20. The apparatus of claim 16, wherein said computing platform is further adapted to:
extract audio pitch information from said electronic video file;
extract motion vector information from said electronic video file; and
generate said fingerprint identifying said electronic video file based at least in part on said audio pitch information as well as on said motion vector information in addition to said color correlogram.

21. The apparatus of claim 16, wherein said computing platform is further adapted to:
determine a quality metric of at least one of said plurality of image frames, wherein said quality metric of said plurality of image frames comprises a quantification of resolution and/or color depth;
select at least one of said plurality of image frames based at least in part on said quality metric of said plurality of image frames;
determine a quality metric of said at least one key frame, wherein said quality metric of said at least one key frame comprises a quantification of resolution and/or color depth;
wherein said extraction of said at least one key frame is based at least in part on said quality metric of said at least one key frame;
extract color information from pixels in said at least one key frame;
quantize said extracted color information into two or more bins;
select spatial information associated with distances between said pixels in said at least one key frame;
wherein said generation of said color correlogram comprises generating said color correlogram based at least in part on said quantization of said extracted color information and said selected distance information;
extract audio pitch information from said electronic video file;
extract motion vector information from said electronic video file; and
generate said fingerprint identifying said electronic video file based at least in part on said audio pitch information as well as on said motion vector information in addition to said color correlogram, and wherein said generation of said fingerprint further comprises generating said fingerprint identifying said electronic video file based at least in part a hash function of said color correlogram.
